(19) United States
(12) Patent Application Publication
(10) Pub. No.: US 2019/0255522 A1
(43) Pub. Date: Aug. 22, 2019

(54) PIPETTING DEVICE WITH AN EASILY REPLACEABLE MAGNET PISTON

(71) Applicant: Hamilton Bonaduz AG, Bonaduz (CH)

(72) Inventors: Hanspeter Romer, Hinwil (CH); Reto Ettinger, Uster (CH); Fridolin Gysel, Adliswil (CH); Heidi Cattaneo, Landquart (CH)

(73) Assignee: Hamilton Bonaduz AG, Bonaduz (CH)

(21) Appl. No.: 16/343,249

(22) PCT Filed: Oct. 11, 2017
(86) PCT No.: PCT/EP2017/075953

§ 371 Date: Apr. 18, 2019

(30) Foreign Application Priority Data
Oct. 18, 2016 (EP) 10 2016 220 425.4

(51) Int. Cl. B01L 3/02

(52) U.S. Cl. CPC B01L 3/0227; B01L 2400/043; B01L 2300/0832; B01L 2200/0605

(57) ABSTRACT

The present invention relates to a pipetting apparatus for aspirating and dispensing metered liquids, encompassing:
at least one guidance tube (30) extending along a cylinder axis (Z), the cylinder axis (Z) defining: an axial direction proceeding along its direction of extent; a radial direction proceeding orthogonally thereto; and a circumferential direction extending therearound;
a piston (10) received in the guidance tube (30) axially movably relative thereto;
a coupling configuration embodied for temporary or permanent coupling of a pipetting tip; and
a drive apparatus (32) for driving the piston (10) to move axially relative to the guidance tube (30),

the guidance tube (30) comprising a coupling-side longitudinal end (48) that is located closer to the coupling configuration; and comprising a servicing-side longitudinal end (50) that is located oppositely from the coupling-side longitudinal end (48) and is located farther from the coupling configuration; the piston (10) encompassing at least one permanent magnet (14a, . . . , 14m); and the drive apparatus (32) comprising an energizable coil arrangement (32) at least partly surrounding the guidance tube (30) in a circumferential direction,

the servicing-side longitudinal end (50) of the guidance tube (30) being open or being openably closed off with an intentionally detachably arranged cover (52), so that a withdrawal longitudinal end (54) of the piston (10), located closer to the servicing-side longitudinal end (50) of the guidance tube (30), is movable by an external magnetic field axially out of the guidance tube.

The present invention relates to a pipetting apparatus for aspirating and dispensing metered liquids, encompassing:
at least one guidance tube extending along a cylinder axis, the cylinder axis defining: an axial direction proceeding along its direction of extent; a radial direction proceeding orthogonally thereto; and a circumferential direction extending therearound;
a piston received in the guidance tube axially movably relative thereto;
a coupling configuration embodied for temporary or permanent coupling of a pipetting tip; and
a drive apparatus for driving the piston to move axially relative to the guidance tube,

the guidance tube comprising a coupling-side longitudinal end that is located closer to the coupling configuration; and comprising a servicing-side longitudinal end that is located oppositely from the coupling-side longitudinal end and is located farther from the coupling configuration; the piston encompassing at least one permanent magnet; and the drive apparatus comprising an energizable coil arrangement at least partly surrounding the guidance tube in a circumferential direction.

A pipetting apparatus of the species is known from WO 2011/083125 A1. This pipetting apparatus is disadvantageous in that any type of seal with which the pipetting piston is sealed with respect to its guidance tube wears very quickly. This is due to the large accelerations and decelerations that are achievable with the magnetic piston, i.e. a pipetting piston having at least one permanent magnet, and with the coil arrangement surrounding the guidance tube. The magnetic piston and the coil arrangement constitute a linear drive system.

The object of the present invention is therefore to refine the pipetting apparatus of the species in such a way that it withstands the seal wear that is elevated as compared with conventional pipetting apparatuses not having a linear-motor drive system.

This object is achieved according to the present invention by a pipetting apparatus of the kind recited previously in which the servicing-side longitudinal end of the guidance tube is open or is openably closed off with an intentionally detachably arranged cover, so that a withdrawal longitudinal end of the piston, located closer to the servicing-side longitudinal end of the guidance tube, is movable by an external magnetic field axially out of the guidance tube.

This conformation, which can be realized only with the linear-motor piston drive system discussed here, thus permits the magnetic piston to be easily extended out of the guidance tube along the cylinder axis. The piston needs to be moved out of the guidance tube only sufficiently far that it can be completely pulled out of the guidance tube by being grasped with a hand or tool. There is therefore no need for complex installation operations such as those necessary when replacing a pipetting piston coupled to conventional mechanical drive systems, for example having a piston driven by a worm-gear or spindle drive, in which at least one piston rod that connects the piston to the drive apparatus is usually provided between the piston and the servicing-side longitudinal end of the guidance tube.

It may merely be necessary to take off a cover that is intentionally detachably arranged on the servicing-side longitudinal end of the guidance tube, if the servicing-side longitudinal end is closed off in intentionally detachable fashion with the cover in order to prevent the ingress of dirt.

In principle, the magnetic piston (pipetting piston) comprising at least one permanent magnet can be moved out of its guidance tube with a sufficiently strong magnetic field of any magnetic field source. But because the drive apparatus already comprises a coil arrangement constituting a magnetic field source for displacing the piston along the cylinder axis of the guidance tube during operation, the coil arrangement is preferably a source of the external magnetic field for extending the withdrawal longitudinal end of the piston. The number of components required for manufacturing the pipetting apparatus can thereby be minimized.

In order to allow the piston to move in positionally accurate fashion along the longitudinal axis with the finest possible axial positional resolution, the coil arrangement preferably comprises at least three separate coil strands, each coil strand being connected to a different phase of a multi-phase, in particular three-phase, power supply. Windings of different coil strands preferably alternate in an axial sequence along the cylinder axis.

Because aspiration in laboratories occurs as a rule from and into containers arranged in grid fashion, from example from microtitration plates having “wells” embodied in grid fashion therein, in order to enhance its operating efficiency the pipetting apparatus of the present invention preferably comprises a plurality of parallel guidance tubes arranged in grid fashion, in each of which an axially movable piston comprising at least one permanent magnet is received, and the servicing-side longitudinal ends of which are each open or are openably closed off with an intentionally detachably arranged cover, and each of which is partly surrounded in a circumferential direction by an energizable coil arrangement constituting part of the drive apparatus. It is not to be excluded, however, that the pipetting apparatus comprises only a single guidance tube and thus only one pipetting channel.

In accordance with a further aspect of the present invention, the object recited previously is also achieved by a method for replacing a linear-motor-driven piston of a pipetting apparatus as described above, the method encompassing the following step:
energizing the coil arrangement in such a way that a withdrawal longitudinal end of the piston, located closer to the servicing-side longitudinal end of the guidance tube, is moved by an external magnetic field axially out of the guidance tube at the servicing-side longitudinal end.

Regarding the advantages of the method according to the present invention, reference may be made to the explanations above of the advantages of the apparatus according to the present invention.

If the guidance tube happens to be closed off at its servicing-side longitudinal end by an intentionally detachably arranged cover in order to prevent the ingress of dirt, the method preferably encompasses the step of removing an intentionally detachably arranged cover from the servicing-side longitudinal end of the guidance tube.

For replacement of the linear-motor-driven piston, the method preferably furthermore encompasses extraction of the piston from the guidance tube and/or insertion of a further piston into the guidance tube. It is thus possible, as has already been explained above, for the magnetic piston to be moved in linear-motor fashion at least part of the way out of the guidance tube, so that an end region of the piston which comprises the withdrawal longitudinal end is no longer surrounded by the guidance tube and can therefore be grasped. Starting at that point in time, the piston can very easily be pulled out, serviced, or replaced with a new or already serviced piston, and the piston provided for further operation of the pipetting apparatus can be inserted into the guidance tube.

In order to bring the pipetting apparatus into an operationally ready state as quickly as possible after a piston replacement, the method according to the present invention furthermore preferably encompasses the step of moving the piston into a reference position, in particular into a reference position defined by a mechanical stop.

The present invention will be explained in more detail below with reference to the appended Figures, in which:

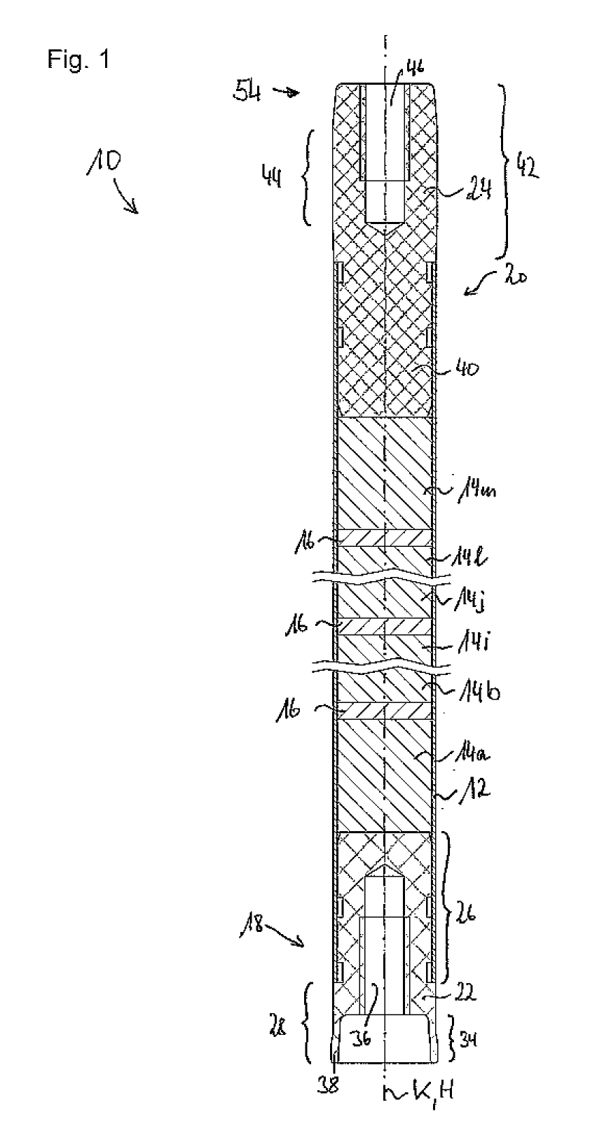

FIG. 1 is a schematic longitudinal section view through an embodiment of a magnetic piston of the present invention; and

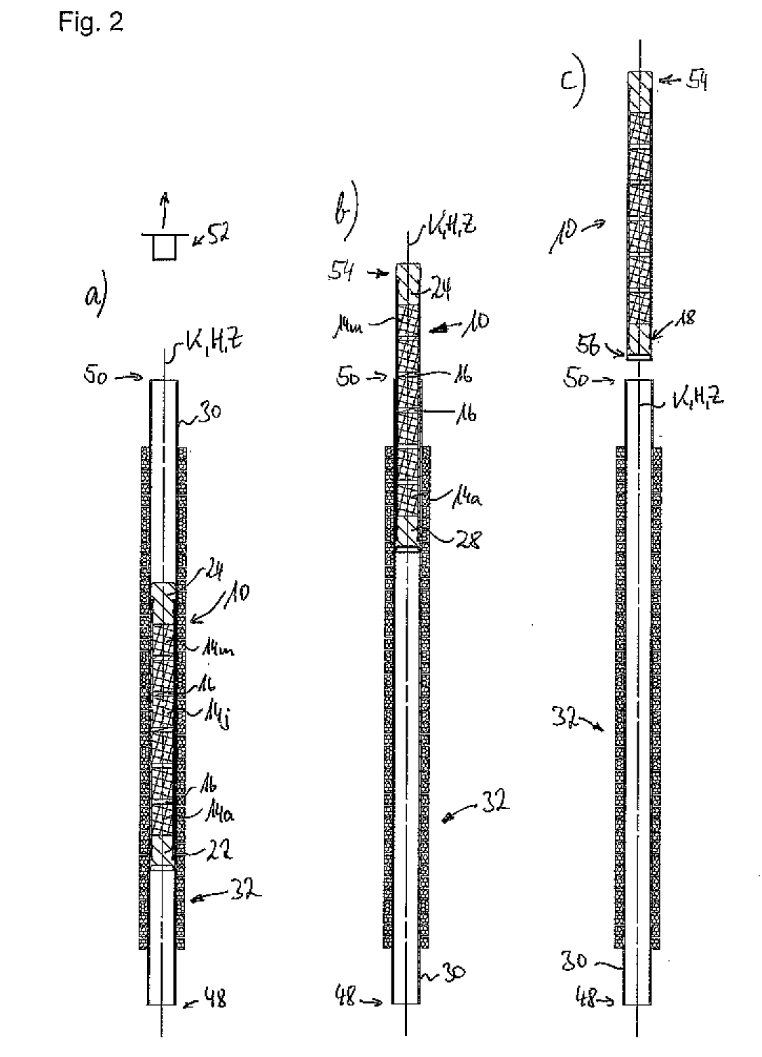

FIGS. 2a to 2c depict an embodiment according to the present invention of a schematically depicted pipetting apparatus having the magnetic piston of FIG. 1, received movably in the guidance tube, in different relative positions relative to the guidance tube; and depict the coil arrangement that surrounds the guidance tube and constitutes a drive apparatus.

In FIG. 1 an embodiment according to the present invention of a magnetic piston, hereinafter also referred to as a “piston subassembly,” of the pipetting apparatus of the present invention is labeled generally with the number 10.

Piston subassembly 10 extends along a piston axis K and encompasses a sheath tube 12 that is concentric with piston axis K and forms a kind of exoskeleton of piston arrangement 10. For strength reasons, sheath tube 12 can be constituted from a nonmagnetic and non-magnetizable metal, for example a high alloy stainless steel. Given weight considerations, however, the sheath tube can also be made of plastic, in particular (for strength reasons) of filled, especially fiber-reinforced plastic.

A sheath-tube axis H thus coincides with piston axis K.

Several permanent-magnet arrangements 14a, . . . , 14i to 14m are preferably arranged in sheath tube 12 successively along piston axis K, a preferably ferromagnetic separating body 16 being arranged between each two directly axially successive permanent-magnet arrangements 14i, 14j.

In the present case, all separating bodies 16 are embodied identically and have a substantially shorter axial length than permanent-magnet arrangements 14i, 14j adjoining them on either side.

Permanent-magnet arrangements 14a to 14m are arranged in such a way that like poles face toward one another at two permanent-magnet arrangements 14i, 14j located axially closest to one another, and adjoin the separating bodies located between those permanent-magnet arrangements. For example, in FIG. 1 the north pole of permanent-magnet arrangement 14a can adjoin separating body 16. The north pole of permanent-magnet arrangement 14b can likewise adjoin separating body 16 located between permanent-magnet arrangements 14a and 14b. Permanent-magnet arrangements 14a to 14m are thus arranged with alternating polarizations along piston axis K in order to generate in the region of separating bodies 16 a magnetic field gradient that is axially as pronounced as possible.

The magnetic field resulting from the arrangement of permanent-magnet arrangements 14a to 14m with alternating polarization serves both to provide a maximally effective coupling of the piston magnetic field to the magnetic field of coil arrangement 32 that surrounds guidance tube 30 (see FIGS. 2a to 2c), in order to furnish an effective linear-motor drive system having maximum positional accuracy, and also to achieve the highest possible resolution for positional sensing of the piston position, for example by way of Hall sensors outside guidance tube 30 along the piston axis (not depicted).

In the present case each permanent-magnet arrangement 14a to 14m is constituted by exactly one permanent magnet. Constituting a permanent-magnet arrangement having a north pole and a south pole from several permanent magnets, or from a combination of permanent magnets and magnetizable components, is not to be excluded, however, if such might be useful in terms of production engineering.

Permanent-magnet arrangements 14a to 14m and separating bodies 16 arranged between them can be adhesively bonded to the inner wall of sheath tube 12 by way of an adhesive film, and thereby secured in position. Sheath tube 12 can be coated with adhesive on its inner wall for that purpose, before the permanent-magnet arrangements and separating bodies 16 are introduced. Additionally or alternatively, the permanent-magnet arrangements and separating bodies can be coated with adhesive on their outer enveloping surfaces.

An adhesive application between permanent-magnet arrangements 14a to 14m and their respectively adjacent separating bodies 16, for example on the end surfaces that respectively touch one another, is possible in principle but not necessary, so that the packing made up of permanent-magnet arrangements 14a and 14m and separating bodies 16 arranged therebetween can be constructed as axially tightly as possible.

Sheath tube 12 in the present case is preferably circularly cylindrical. In the present case, permanent-magnet arrangements 14a are preferably solidly circularly cylindrical, as are the soft-magnetic, preferably ferromagnetic, separating bodies 16.

Sheath tube 12 comprises at one end a sealing longitudinal end 18, and comprises a further longitudinal end 20 located oppositely from sealing longitudinal end 18.

A sealing arrangement 22 in the form of a sealing component is preferably provided at sealing longitudinal end 18. A sealing component 22, or centering component 24 depicted in FIG. 1, can likewise be provided at the oppositely located longitudinal end 20.

Sealing component 22 comprises a connecting portion 26 that projects axially into sheath tube 12 at its sealing longitudinal end 18 and can likewise be adhesively bonded to the inner wall of sheath tube 12 by means of an adhesive.

Sealing component 22 furthermore comprises a sealing portion 28 that protrudes in an axial direction away from sheath tube 12. This sealing portion 28 preferably comprises a sleeve configuration 34 that, for example, can be embodied in a bell shape widening axially away from sheath tube 12. A portion of sleeve configuration 34 protrudes radially beyond sheath tube 12 so that it can come into abutment against guidance tube 30 without interference from sheath tube 12, and can thereby perform its sealing function.

The sealing arrangement or sealing component 22 can comprise a central recess 36 into which a tool or a threaded rod can be threaded so that, for example, sealing component 22 can be pulled out of sheath tube 12 or so that it can be pressed radially against the inner wall of sheath tube 12 and thereby anchored more strongly on sheath tube 12.

That region of sleeve portion 34 which projects radially beyond sheath tube 12 forms a sealing lip 38 proceeding around piston axis K.

Centering component 24, shown by way of example at the other longitudinal end 20 of sheath tube 12, also comprises a fastening portion 40 that, analogously to connecting portion 26, is introduced axially into sheath tube 12 from longitudinal end 20. Fastening portion 40 can also be connected adhesively, by way of an adhesive, to the inner wall of sheath tube 12. Centering component 24 furthermore comprises a centering portion 42 that protrudes axially out of sheath tube 12 and beyond it, an effective portion 44 of centering portion 42 having a radially larger dimension than sheath tube 12 and projecting radially beyond the latter either along the entire circumference or locally in distributed fashion around the circumference. The radial projection of effective portion 44 is preferably less than the radial projection of sleeve portion 34 of centering component 22 in order to avoid unnecessary frictional resistance at centering component 24. Centering component 24 serves, together with sealing component 22, to avoid contact between sheath tube 12 and the guidance tube that surrounds it in an operational context.

Centering component 24 as well can comprise a recess 46, accessible from its free longitudinal end, into which a tool is introducible and fastenable for easier removal of centering component 24 from sheath tube 12. Contrary to what is depicted in FIG. 1, recess 46 can extend axially into the region of sheath tube 12 and can serve to press centering component 24 radially against the inner wall of sheath tube 12. Centering component 24 and sealing component 22, which preferably are constituted in one piece, are preferably embodied from plastic, specifically from a filled thermoplastic, the plastic matrix preferably being polytetrafluoroethylene or a polyolefin, and solid particles of mica or graphite being embedded therein. Particularly low-friction and low-wear contact with guidance tube 30 that surrounds piston subassembly 10 in an operational context is thereby enabled.

FIGS. 2a to 2c show piston subassembly 10 of FIG. 1 in various relative positions.

By corresponding energization of coil arrangement 32, permanent-magnet piston subassembly 10 can be moved quickly and highly accurately along cylinder axis Z, which coincides with piston axis K during operation, of guidance tube 30.

Guidance tube 30 comprises a coupling longitudinal end 48 located closer to a coupling configuration (not depicted in FIG. 2) and, oppositely from it, a servicing-side longitudinal end or servicing longitudinal end 50.

Axially adjacent to coupling longitudinal end 48 is a region of the pipetting apparatus (not depicted in FIGS. 2a to 2c) to which guidance tube 30 belongs, a coupling configuration being provided thereon in a manner known per se for detachable temporary coupling of a pipetting tip.

In the example depicted, servicing-side longitudinal end 50 of guidance tube 30 is open. It can also be closed off by a cover 52 that is intentionally detachably arranged at servicing-side longitudinal end 50 and that constitutes an end stop of piston subassembly 10 in order to limit its axial motion path toward servicing-side longitudinal end 50.

After any removal of detachable cover 52, piston subassembly 10 can be moved in simple fashion axially out of guidance tube 30 at least far enough that its removal longitudinal end 54, constituted by centering component 24, is no longer surrounded by guidance tube 30 and can thus be grasped manually or with a tool. It is thereby possible to pull piston subassembly 10 axially completely out of guidance tube 30 and remove it completely from the guidance tube.

A serviced or new piston subassembly 10 can then be slid axially, starting with a piston-sealing longitudinal end 56 having sealing component 22, far enough into guidance tube 30 (see FIG. 2c) that a magnetic field generatable by coil arrangement 32 is thereby couplable to the magnetic field of permanent-magnet arrangements 14a to 14m sufficiently that piston subassembly 10 can be pulled by the magnetic field of coil arrangement 32 completely into guidance tube 30. Cover 52 can then be mounted again, if necessary, on servicing-side longitudinal end 50 of guidance tube 30.

In order to set up the pipetting apparatus to be ready for operation again after a replacement of piston subassembly 10, coil arrangement 32 can move the pulled-in piston subassembly 10 into a defined reference position, determined e.g. by a mechanical stop, in which its sensor system becomes referenced to the known position. The pipetting arrangement is then once again ready for operation with high dynamics and high accuracy.

1. A pipetting apparatus for aspirating and dispensing metered liquids, comprising:
at least one guidance tube extending along a cylinder axis, the cylinder axis defining: an axial direction proceeding along its direction of extent; a radial direction proceeding orthogonally thereto; and a circumferential direction extending therearound;
a piston received in the guidance tube axially movably relative thereto;
a coupling configuration embodied for temporary or permanent coupling of a pipetting tip; and
a drive apparatus for driving the piston to move axially relative to the guidance tube,
the guidance tube comprising a coupling-side longitudinal end that is located closer to the coupling configuration; and comprising a servicing-side longitudinal end that is located oppositely from the coupling-side longitudinal end and is located farther from the coupling configuration; the piston encompassing at least one permanent magnet; and the drive apparatus comprising an energizable coil arrangement at least partly surrounding the guidance tube in a circumferential direction,
wherein the servicing-side longitudinal end of the guidance tube is open or is openably closed off with an intentionally detachably arranged cover, so that a withdrawal longitudinal end of the piston, located closer to the servicing-side longitudinal end of the guidance tube, is movable by an external magnetic field axially out of the guidance tube.

2. The pipetting apparatus according to claim 1, wherein the coil arrangement is a source of the external magnetic field for extending the withdrawal longitudinal end of the piston.

3. The pipetting apparatus according to claim 1, wherein the coil arrangement comprises at least three separate coil strands, each coil strand being connected to a different phase of a three-phase, power supply.

4. The pipetting apparatus according to claim 1, further comprising a plurality of parallel guidance tubes arranged in grid fashion, in each of which an axially movable piston comprising at least one permanent magnet is received, and the servicing-side longitudinal ends of which are each open or are openably closed off with an intentionally detachably arranged cover, and each of which is partly surrounded in a circumferential direction by an energizable coil arrangement constituting part of the drive apparatus.

5. A method for replacing a linear-motor-driven piston of a pipetting apparatus according to claim 1, the method comprising the following step:
energizing the coil arrangement in such a way that a withdrawal longitudinal end of the piston, located closer to the servicing-side longitudinal end of the guidance tube, is moved by an external magnetic field axially out of the guidance tube at the servicing-side longitudinal end.

6. The method according to claim 5, further comprising the step of removing an intentionally detachably arranged cover from the servicing-side longitudinal end of the guidance tube.

7. The method according to claim 5, further comprising extraction of the piston from the guidance tube and/or insertion of a further piston into the guidance tube.

8. The method according to claim 5, further comprising the step of moving the piston into a reference position.

9. The pipetting apparatus according to claim 2, wherein the coil arrangement comprises at least three separate coil strands, each coil strand being connected to a different phase of a three-phase, power supply.

10. The pipetting apparatus according to claim 2, further comprising a plurality of parallel guidance tubes arranged in grid fashion, in each of which an axially movable piston comprising at least one permanent magnet is received, and the servicing-side longitudinal ends of which are each open or are openably closed off with an intentionally detachably arranged cover, and each of which is partly surrounded in a circumferential direction by an energizable coil arrangement constituting part of the drive apparatus.

11. The pipetting apparatus according to claim 3, further comprising a plurality of parallel guidance tubes arranged in grid fashion, in each of which an axially movable piston comprising at least one permanent magnet is received, and the servicing-side longitudinal ends of which are each open or are openably closed off with an intentionally detachably arranged cover, and each of which is partly surrounded in a circumferential direction by an energizable coil arrangement constituting part of the drive apparatus.

12. A method for replacing a linear-motor-driven piston of a pipetting apparatus according to claim 2, the method comprising the following step:
energizing the coil arrangement in such a way that a withdrawal longitudinal end of the piston, located closer to the servicing-side longitudinal end of the guidance tube, is moved by an external magnetic field axially out of the guidance tube at the servicing-side longitudinal end.

13. A method for replacing a linear-motor-driven piston of a pipetting apparatus according to claim 3, the method comprising the following step:
energizing the coil arrangement in such a way that a withdrawal longitudinal end of the piston, located closer to the servicing-side longitudinal end of the guidance tube, is moved by an external magnetic field axially out of the guidance tube at the servicing-side longitudinal end.

14. A method for replacing a linear-motor-driven piston of a pipetting apparatus according to claim 4, the method comprising the following step:
energizing the coil arrangement in such a way that a withdrawal longitudinal end of the piston, located closer to the servicing-side longitudinal end of the guidance tube, is moved by an external magnetic field axially out of the guidance tube at the servicing-side longitudinal end.

15. The method according to claim 6, further comprising extraction of the piston from the guidance tube and/or insertion of a further piston into the guidance tube.

16. The method according to claim 6, further comprising the step of moving the piston into a reference position.

17. The method according to claim 7, further comprising the step of moving the piston into a reference position.

18. The method according to claims 5, further comprising the step of moving the piston into a reference position defined by a mechanical stop.

19. The method according to claims 6, further comprising the step of moving the piston into a reference position defined by a mechanical stop.

20. The method according to claims 7, further comprising the step of moving the piston into a reference position defined by a mechanical stop.
